(19) United States
(12) Patent Application Publication
(10) Pub. No.: US 2023/0081271 A1
(43) Pub. Date: Mar. 16, 2023

(54) METHOD FOR DISPLAYING COMMERICIAL ADVERTISEMENTS IN VIRTUAL REALITY SCENE

(71) Applicant: Fei TENG, Beijing (CN)

(72) Inventor: Fei TENG, Beijing (CN)

(21) Appl. No.: 17/473,941

(22) Filed: Sep. 13, 2021

(51) Int. Cl. A63F 13/61; A63F 13/48; G06Q 30/02

(52) U.S. Cl. CPC A63F 13/61; A63F 13/48; G06Q 30/0277; G06F 3/04842

(57) ABSTRACT

A method for displaying commercial advertisements in a virtual reality is disclosed. A user enters the virtual reality visually and audibly through a virtual reality device, the virtual reality device displays a virtual reality application desktop for the user at the same time, and when the user selects the virtual reality application or game, the virtual reality application or game is loaded, in the loading wait process, the user enters the virtual game from the real world through virtual pictures close to reality, which can reduce the abrupt feeling from the real world to the virtual world and avoid the perceived impact caused by the user directly entering the game environment, and the VR application can still continue to load their resources asynchronously. During the long-term VR game, by displaying a close to reality or semi-independent or independent scene, the vision and audition of the user can be relaxed.

### TECHNICAL FIELD

The present disclosure relates to the field of virtual reality (VR) application, and more specifically, to a method for displaying commercial advertisements in a virtual reality scene.

### BACKGROUND ART

Virtual reality (VR) technologies, also known as spiritual technologies, are brand-new practical technologies developed in the 20th century. The VR technologies include computer, electronic information and simulation technology, and its basic realization way is to simulate virtual environment by computer, so as to give people a sense of environmental immersion.

In the virtual reality (VR), the display scene and display of advertisements and commercial contents are not friendly, which leads to a user not accepting the advertisements and commercial contents. The main attempted method of existing advertisements and commercial contents is pop-up advertisements, which is similar to computer pop-up advertising, and the publicity effect is not ideal. Moreover, the VR application desktop directly enters the real application (game) after loading, and the visual and auditory impact are great, which cause the user to have uncomfortable feelings.

Therefore, a method for displaying commercial advertisements in a virtual reality scene is provided therewith, which can reduce the abrupt feeling of the user from the real world to the virtual world, and avoid the perceptual impact caused by the user's entering into the game environment directly. The VR application can still continue to load its resources asynchronously, meaning that during the waiting of the VR application loading data by the user, an advertisement scene is shown, the user's awareness of the real world is converted into the virtual world, thus improving the advertising effect and the product value. At the same time, in the long-time virtual reality game process, the process of long-time will cause vision and audition to be divorced from the reality and easy to have the uncomfortable feeling, the addition of virtual scene close to the reality in the game can alleviate the user's uncomfortable feeling.

### SUMMARY

The purpose of the present disclosure is to provide a method for displaying commercial advertisements in a virtual reality scene, and to solve the problems set forth in the background art.

In order to achieve the above purpose, the present disclosure provides the following technical scheme. A method for displaying commercial advertisements in a virtual reality scene including: entering a virtual reality visually and audibly by a user through a virtual reality device, displaying a virtual reality application desktop to the user by the virtual reality device at the same time, loading a virtual reality application or a game when the user selects a virtual reality application or a game, in a loading wait process, loading a virtual display virtual scene at the same time, entering the virtual display virtual scene by the user, displaying commercial and advertisement contents to the user, entering the virtual reality application and the game from the virtual scene by the user after the loading is completed.

As a preferred embodiment of the present disclosure, the virtual scene is a virtual scene displaying commercial advertisements close to reality.

As a preferred embodiment of the present disclosure, the independent or semi-independent virtual scene is constructed in the virtual reality application, game and desktop state. The virtual scene is a virtual reality virtual scene close to displaying a commercial and advertisement mode in reality.

As a preferred embodiment of the present disclosure, the user accepts the virtual scene with advertisements and commercial contents displayed in the virtual reality in the virtual reality application, game, desktop and other state.

As a preferred embodiment of the present disclosure, in the virtual reality application, game and desktop state, the user enters the independent or semi-independent virtual scene directly in the virtual reality game. The virtual scene is a virtual reality virtual scene displaying a commercial and advertisement mode close to reality, and can meet the needs of displaying commercial or advertisement contents for the user.

Compared with the prior art, the disclosure has the following beneficial effects:

1. According to the disclosure, the user enters the virtual game from the real world through virtual pictures close to reality, which can reduce the abrupt feeling from the real world to the virtual world and avoid the perceived impact caused by the user directly entering the game environment. The VR application can still continue to load their resources asynchronously, during the user's long-term VR game, by displaying a close to reality or semi-independent or independent scene, the vision and audition of the user can be relaxed, and the discomfort in long-term VR game can be reduced.

2. According to the disclosure, through the setting of the virtual scene, the cognitive translation of the user to the real world is converted into the virtual world through the virtual virtual scene, so that the advertising effect can be improved. The virtual reality articles are more stereoscopic, and the virtual reality products are more comprehensively understood. Moreover, the publicity method is more novel and easy to be accepted by users, compared with the existing advertisements and commercial content display methods, it will greatly improve the acceptance of users and the conversion rate of advertisements and commercial contents.

### BRIEF DESCRIPTION OF THE DRAWINGS

Other features, objects and advantages of the present disclosure will become more apparent by reading the detailed description of non-limiting embodiments with reference to the following drawings:

FIG. 1 is a first scene diagram of a method for displaying commercial advertisements in a virtual reality scene according to the present disclosure.

FIG. 2 is a second scene diagram of a method for displaying commercial advertisements in a virtual reality scene according to the present disclosure.

### DETAILED DESCRIPTION OF THE EMBODIMENTS

In order to make the technical means, creative features, achievement of objectives and efficacy of the present disclosure easy to be understood, the present disclosure will be further explained with specific embodiments. It should be noted that if there are directional indications (such as up, down, left, right, front, back, . . . ) in the embodiment of the present disclosure, the directional indications are only used to explain the relative position relationship and movement situation among components in a certain specific posture (as shown in the figure), and if the specific posture changes, the directional indications will change accordingly.

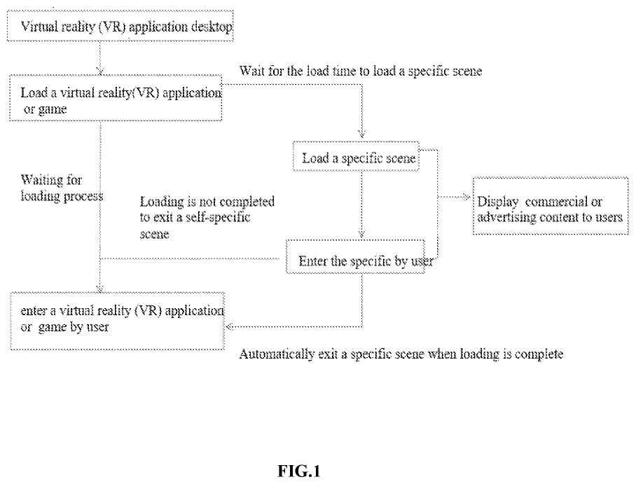

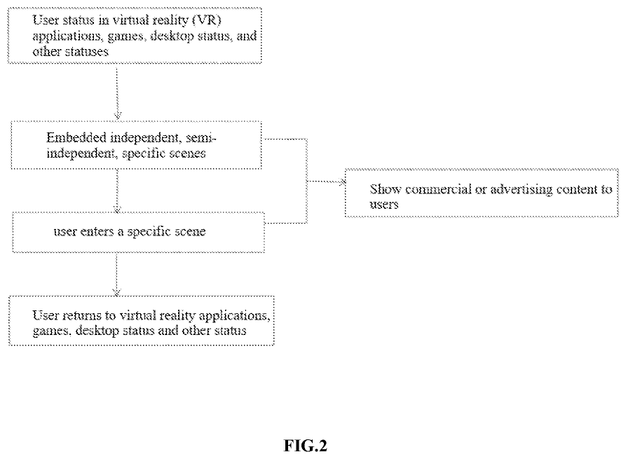

Referring to FIGS. 1-2, the present disclosure provides a technical scheme as below. A method for displaying commercial advertisements in a virtual reality scene includes the steps of: entering a virtual reality visually and audibly by a user through a virtual reality device, displaying a virtual reality application desktop to the user by the virtual reality device at the same time, loading a virtual reality application or a game when the user selects a virtual reality application or a game, loading a virtual display virtual scene at the same time in a loading wait process, entering the virtual display virtual scene by the user, displaying commercial and advertisement contents to the user, entering the virtual reality application and the game from the virtual scene by the user after the loading is completed. The process of waiting for loading includes the time when the game is loaded, the user waits for resurrection in the game, and all the waiting time for loading in the virtual reality applications.

In this embodiment (referring to FIGS. 1-2), the virtual scene is a virtual scene displaying commercial advertisements close to reality.

In this embodiment (refer to FIG. 1-2), the independent or semi-independent virtual scene is constructed in a virtual reality application, game and desktop state. The virtual scene is a virtual reality virtual scene close to displaying a commercial and advertisement mode in reality.

In this embodiment (referring to FIGS. 1-2), in the virtual reality application, game, desktop and other state, the user accepts the virtual scene of the advertisement and commercial contents displayed in the virtual reality.

In this embodiment (referring to FIGS. 1-2), in the virtual reality application, game and desktop state, the user enters the independent or semi-independent virtual scene directly in the virtual reality game. The virtual scene is a virtual reality virtual scene close to displaying a commercial and advertisement mode in reality, and can meet the needs of displaying commercial or advertisement contents for the user.

### Specific Embodiment 1

The user's vision and audition enter into the virtual reality by wearing the VR device. The virtual reality application is displayed on the desktop within the user's vision. The user enters into a game by selecting the application (game) to be loaded through the operation of the VR device. In the loading process of the game or in the transition time between two scenes through the pictures, for example, a user enters a virtual elevator and stands in an elevator to surround a line of sight, a segmented advertisement or a television screen is placed in the virtual elevator, and a user leaves a display scene close to reality to enter a real application (game).

### Specific Embodiment 2

The user's vision and audition enter into the virtual reality by wearing the VR device. The virtual reality application is displayed on the desktop within the user's vision. The user enters into a game by selecting the application (game) to be loaded through the operation of the VR device. In the loading process of the game or in the transition time between two scenes through the pictures, the main character in the game passes by a room to find clues, the user enters a virtual home room to surround the line of sight, the advertisements are displayed on the TV in the virtual room. The items in the room are placed in order. The user leaves the display scene close to reality to enter the real application (game).

### Specific Embodiment 3

The user's vision and audition enter into the virtual reality after wearing the VR device by a user and the virtual reality application is displayed on the desktop within the user's vision. The user enters into a game by selecting the application (game) to be loaded through the operation of the VR device. A display scene close to reality is put in the loading process of the game or in the transition time between two scenes through the pictures. The advertisement scene can be integrated in the display scene close to reality, and a user can adapt to virtual reality through the advertisement scene in the display scene close to reality. In the advertisement scene, a garage for parking vehicles is provided therewith and the vehicles can be rotated by the operation of the VR device. Or, the interior of the vehicle can be observed. With the completion of the game loading, the user leaves the display scene close to reality and enters the real application (game), and the automobile products can thus be advertised in such a manner.

### Specific Embodiment 4

The user's vision and audition enter into the virtual reality after wearing the VR device by a user. The virtual reality application is displayed on the desktop within the user's vision. The user enters into a game by selecting the application (game) to be loaded through the operation of the VR device. In the loading process of the game or the transition time between two scenes through the pictures, and in the waiting process during the loading the application (game), the display scene close to reality is added and an advertisement scene can be integrated into the display scene close to reality. The user can adapt to virtual reality through an advertisement scene in the display scene close to reality, by operating the VR device in the advertisement scene, the wardrobe is opened, and different clothes can be selected for matching, with the completion of the game loading, the user leaves the display scene into the real application (game), and the clothing products can be advertised.

### Specific Embodiment 5

The user's vision and audition enter into the virtual reality after wearing the VR device by a user, and the virtual reality application is displayed on the desktop within the user's vision. The user enters into a game by selecting the application (game) to be loaded through the operation of the VR device, during the user's long-time game, such as entering the resurrection waiting process or during the transitional loading process, a close to reality or semi-independent or independent scene can be displayed, so that the vision and audition of the user can be relaxed. The long-time vision and audition break away from the discomfort of entering virtual reality, and the tension of users in the game can be relaxed through the displayed virtual scene, and the advertising effect of business and advertisements in the virtual scene can also be improved.

When in use, the VR device is wear by a user and the user's vision and audition enter into the virtual reality. The virtual reality application is then displayed on the desktop within the user's vision. The user enters into a game by selecting the application (game) to be loaded through the operation of the VR device, while it takes time to load the application (game), during the waiting process of loading the application (game), the display scene close to reality is added and an advertisement scene can be integrated in the display scene close to reality. The user adapts to virtual reality through the advertisement scene in the display scene close to reality, or enters into an independent or semi-independent virtual scene, which are virtual scenes that are often contacted by reality, thus reducing the user's discomfort and avoiding the impact of directly entering the virtual game screen on the user. The user leaves the display scene close to reality to the real application (game) after the completion of loading the game. During the user's long hours game, the user enters the resurrection waiting process, or during the transition loading process, a scene close to reality or semi-independent or independent scene is displayed to relax the user's vision and audition, thus reducing discomfort.

The above shows and describes the basic principles and main features of the present disclosure and its advantages, it is obvious to those skilled in the art that the present disclosure is not limited to the details of the above exemplary embodiments, but can be realized in other specific forms without departing from the spirit or basic features of the present disclosure. Therefore, the embodiments should be regarded as exemplary and non-limiting from any point of view, and the scope of the present disclosure is defined by the appended claims rather than the above description, so it is intended to embrace all changes falling within the meaning and range of equivalent elements of the claims. Any reference signs in the claims should not be regarded as limiting the claims involved.

In addition, it should be understood that although this specification is described according to embodiments, each embodiment does not contain only one independent technical solution, the description of this specification is only for the sake of clarity, and those skilled in the art should take the specification as a whole, the technical solutions in each embodiment can also be combined appropriately to form other embodiments that can be understood by those skilled in the art.

What is claimed is:

1. A method for displaying commercial advertisements in a virtual reality scene, comprising:
entering a virtual reality visually and audibly, by a user, through a virtual reality device;
displaying a virtual reality application desktop to the user by the virtual reality device at the same time;
loading a virtual reality application or a game when the user selects a virtual reality application or a game;
loading a virtual display virtual scene at the same time during the loading;
entering the virtual display virtual scene, by the user, and displaying commercial and advertisement contents to the user; and
entering the virtual reality application and the game from the virtual scene, by the user, after the loading is completed.

2. The method of claim 1, wherein the virtual scene is a virtual scene displaying a commercial advertisement close to reality; and the virtual scene is an independent or semi-independent virtual scene.

3. The method of claim 1, wherein an independent or semi-independent virtual scene is constructed in a virtual reality application, the game and a desktop state; and the virtual scene is a virtual reality virtual scene close to the realistic commercial display and advertisement mode.

4. The method of claim 1, wherein in the virtual reality application, the game and the desktop state, the user accepts the virtual scene of the advertisement and commercial contents displayed in the virtual reality.

5. The method of claim 3, wherein in the virtual reality application, the game and the desktop state, the user enters the independent or semi-independent virtual scene directly in the virtual reality game; the virtual scene is a virtual reality virtual scene close to the realistic commercial display and advertisement mode and can meet the needs of displaying commercial or advertisement contents for the user.
